(19) United States
(12) Patent Application Publication
(10) Pub. No.: US 2025/0132955 A1
(43) Pub. Date: Apr. 24, 2025

(54) SYSTEMS AND METHODS FOR NOISE POWER ESTIMATION IN WIRELESS COMMUNICATIONS

(71) Applicant: Samsung Electronics Co., Ltd., Suwon-si (KR)

(72) Inventors: Mojtaba RAHMATI, San Diego, CA (US); Hyukjoon KWON, San Diego, CA (US); Dongwoon BAI, San Diego, CA (US)

(21) Appl. No.: 18/888,144

(22) Filed: Sep. 17, 2024

Related U.S. Application Data
(60) Provisional application No. 63/545,281, filed on Oct. 23, 2023.

(51) Int. Cl. H04L 25/02; H04L 25/03

(52) U.S. Cl. CPC H04L 25/0258; H04L 25/03006

(57) ABSTRACT

A system and a method are disclosed for noise power estimation in wireless communications. In some embodiments, the method includes: receiving a reference signal; generating a first channel estimate, based on the reference signal; calculating a first noise power estimate; calculating a corrected noise power estimate by applying a multiplicative correction based on a linear minimum mean square error filter weight to the first noise power estimate; receiving a transmission; and decoding the transmission, based on the corrected noise power estimate.

### CROSS-REFERENCE TO RELATED APPLICATION

This application claims the priority benefit under 35 U.S.C. § 119(e) of U.S. Provisional Application No. 63/545,281, filed on Oct. 23, 2023, the disclosure of which is incorporated by reference in its entirety as if fully set forth herein.

### TECHNICAL FIELD

The disclosure generally relates to wireless communication. More particularly, the subject matter disclosed herein relates to improvements to systems and methods for noise power estimation in wireless communications.

### SUMMARY

When a digital signal is received over a wireless channel, soft decision decoding may be employed to decode the received data, in units that may be referred to as code blocks. The decoding may involve estimating the likelihood that each transmitted bit was a zero or a one. This estimating may require an estimate of the noise in the channel, however, which may not be known a priori.

To solve this problem the noise in the received signal may be estimated.

One issue with the above approach is that a noise power estimation algorithm may depend on a channel estimate, and that as such, an imperfect channel estimate may result in error in the noise power estimate.

To overcome these issues, systems and methods are described herein for noise power estimation in the presence of channel estimation error.

The above approaches improve on previous methods because they provide improved noise power estimates in the presence of channel estimation errors than methods that do not take channel estimation error into account.

According to an embodiment of the present disclosure, there is provided a method, including: receiving a reference signal; generating a first channel estimate, based on the reference signal; calculating a first noise power estimate; calculating a corrected noise power estimate by applying a multiplicative correction based on a linear minimum mean square error filter weight to the first noise power estimate; receiving a transmission; and decoding the transmission, based on the corrected noise power estimate.

In some embodiments, the method, further includes calculating a second noise power estimate, wherein the calculating of the first channel estimate includes calculating the first channel estimate further based on the second noise power estimate.

In some embodiments, the method, further includes: generating a second channel estimate, based on the reference signal and on a fourth noise power estimate; and calculating a third noise power estimate, wherein the calculating of the second noise power estimate includes calculating the second noise power estimate by applying a correction to the third noise power estimate.

In some embodiments, the calculating of the corrected noise power estimate includes calculating the corrected noise power estimate by further applying an additive correction to the first noise power estimate.

In some embodiments, the additive correction is based on the second noise power estimate.

In some embodiments, the additive correction is further based on one or more linear minimum mean square error filter weights.

In some embodiments, the multiplicative correction is further based on a time domain interpolation weight.

In some embodiments, the multiplicative correction is further based on a correlation time of a channel corresponding to the first channel estimate.

According to an embodiment of the present disclosure, there is provided a system including: one or more processors; and a memory storing instructions which, when executed by the one or more processors, cause performance of: receiving a reference signal; generating a first channel estimate, based on the reference signal; calculating a first noise power estimate; calculating a corrected noise power estimate by applying a multiplicative correction based on a linear minimum mean square error filter weight to the first noise power estimate; receiving a transmission; and decoding the transmission, based on the corrected noise power estimate.

In some embodiments: the instructions, when executed by the one or more processors, further cause performance of calculating a second noise power estimate; and the calculating of the first channel estimate includes calculating the first channel estimate further based on the second noise power estimate.

In some embodiments, the instructions, when executed by the one or more processors, further cause performance of: generating a second channel estimate, based on the reference signal and on a fourth noise power estimate; and calculating a third noise power estimate, wherein the calculating of the second noise power estimate includes calculating the second noise power estimate by applying a correction to the third noise power estimate.

In some embodiments, the calculating of the corrected noise power estimate includes calculating the corrected noise power estimate by further applying an additive correction to the first noise power estimate.

In some embodiments, the additive correction is based on the second noise power estimate.

In some embodiments, the additive correction is further based on one or more linear minimum mean square error filter weights.

In some embodiments, the multiplicative correction is further based on a time domain interpolation weight.

In some embodiments, the multiplicative correction is further based on a correlation time of a channel corresponding to the first channel estimate.

According to an embodiment of the present disclosure, there is provided a system including: means for processing; and a memory storing instructions which, when executed by the means for processing, cause performance of: receiving a reference signal; generating a first channel estimate, based on the reference signal; calculating a first noise power estimate; calculating a corrected noise power estimate by applying a multiplicative correction based on a linear minimum mean square error filter weight to the first noise power estimate; receiving a transmission; and decoding the transmission, based on the corrected noise power estimate.

In some embodiments, the instructions, when executed by the means for processing, further cause performance of calculating a second noise power estimate, wherein the calculating of the first channel estimate includes calculating the first channel estimate further based on the second noise power estimate.

In some embodiments, the instructions, when executed by the means for processing, further cause performance of: generating a second channel estimate, based on the reference signal and on a fourth noise power estimate; and calculating a third noise power estimate, wherein the calculating of the second noise power estimate includes calculating the second noise power estimate by applying a correction to the third noise power estimate.

In some embodiments, the calculating of the corrected noise power estimate includes calculating the corrected noise power estimate by further applying an additive correction to the first noise power estimate.

### BRIEF DESCRIPTION OF THE DRAWINGS

In the following section, the aspects of the subject matter disclosed herein will be described with reference to exemplary embodiments illustrated in the figures, in which:

FIG. 1 shows a system including a UE and a gNB in communication with each other, according to an embodiment.

FIG. 2 is a block diagram illustrating channel estimation, according to an embodiment.

FIG. 3 is a flow chart, according to an embodiment.

FIG. 4 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “or” should be interpreted as “and/or”, such that, for example, “A or B” means any one of “A” or “B” or “A and B”.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” (or “means for processing”) refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

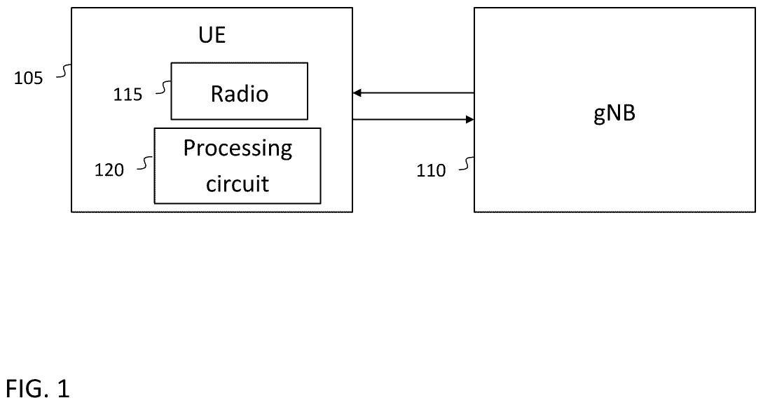

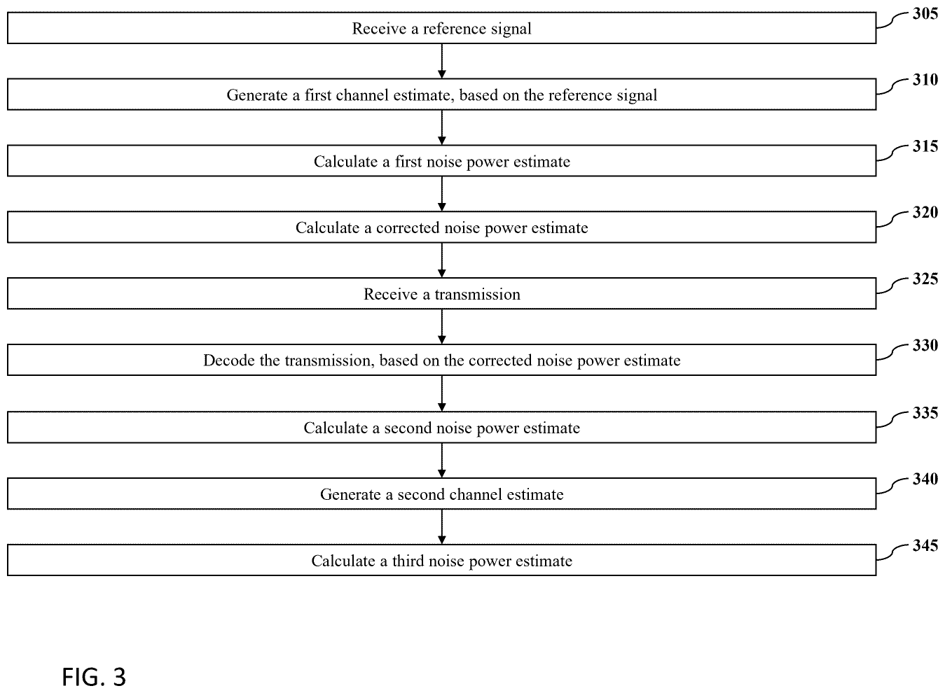

FIG. 1 shows a system including a user equipment (UE) 105 and a network node (gNB) 110, in communication with each other. The UE 105 may be a user device capable of connecting to a wireless network (e.g., a fifth generation (5G) cellular network), e.g., a mobile telephone, or a laptop or tablet computer capable of accessing the wireless network. The UE 105 may include a radio 115 and a processing circuit (or a means for processing) 120, which may perform various methods disclosed herein, e.g., the method illustrated in FIG. 3. For example, the processing circuit 120 may receive, via the radio 115, transmissions from the network node (gNB) 110, and the processing circuit 120 may transmit, via the radio 115, signals to the gNB 110.

In operation, the UE 105 may receive (i) a reference signal (e.g., a demodulation reference signal (DMRS) and (ii) data transmissions (e.g., physical downlink shared channel (PDSCH) transmissions) from the gNB 110. The UE 105 may (i) perform noise power estimation and channel estimation (CE) based on the received DMRS and (ii) perform decoding of the other transmissions using the estimated noise and the estimated channel characteristics. The channel estimation may be based on a noise power estimate, and another noise power estimate may be calculated, based on the received DMRS and on the channel estimate, once the channel estimate has been calculated. The latter noise power estimate may be used for decoding. Errors (e.g., imperfections) in the channel estimate may however cause the noise power estimate to be inaccurate, which may result in degraded decoding performance. As such, improved noise power estimates, calculated using methods disclosed herein, may be used to improve decoding performance. As used herein, “noise” (except in the phrase “signal to interference and noise ratio” (SINR)) means the portion of the received signal that is not directly due to the transmitted signal (e.g., the signal transmitted by the gNB), and, as such, “noise” as used herein includes, for example, interference. As used herein, a “noise power estimate” is any quantity (e.g., the standard deviation of the noise) from which the noise power can be inferred.

The connection between the UE 105 and the gNB 110 may be a multiple-input-multiple-output orthogonal frequency division multiplexed (MIMO-OFDM) system, and in operation the UE 105 may perform frequency domain estimation of the ratio of the signal power to the noise power. This ratio may be referred to as the “signal to interference and noise ratio (SINR), because “noise” (except in the phrase “signal to interference and noise ratio”) includes interference, as discussed above).

A single resource block (RB) and a single receive antenna, and either one DMRS port or two DMRS ports may be used. For the single DMRS port case, the descrambled received signal yₖ over k-th demodulation reference signal (DMRS) resource element (RE) may be modelled as

$${y}_{k} = {h}_{k} + {n}_{k}$$

Where hₖ is the channel frequency response, and nₖ˜N(0, σₙ²) with σₙ² being the noise power. For the two DMRS port case where the two layers are multiplexed by frequency domain orthogonal cover codes (FD-OCC), the descrambled received signal over the k-th DMRS RE may be modelled as

yₖ=h_{0,k}x₀+h_{1,k}x₁+nₖ, where h_{i,k} is the channel frequency response for the i^{th} layer, and xᵢ is the transmitted signal in the i^{th} layer.

Furthermore, the following definition may be used:

$$y = [ \begin{matrix}{y}_{0} \\ ⋮ \\ {y}_{{N}_{p} - 1}\end{matrix} ]$$

where Nₚ is the numbers of samples, where for the one DMRS port case

$$y = h + n$$

where h and n are analogously defined vectors, with n·N(0, σₙ²I_{N}_{ₚ}) (with I_{N}_{ₚ} a Nₚ-dimensional identity matrix and Nₚ the number of DMRS samples) and, for the two DMRS port case

$$y = {X}_{0} {h}_{0} + {X}_{1} {h}_{1} + n$$

where X₀=I_{N}_{ₚ} and X₁=diag(1, −1, . . . , 1, −1).

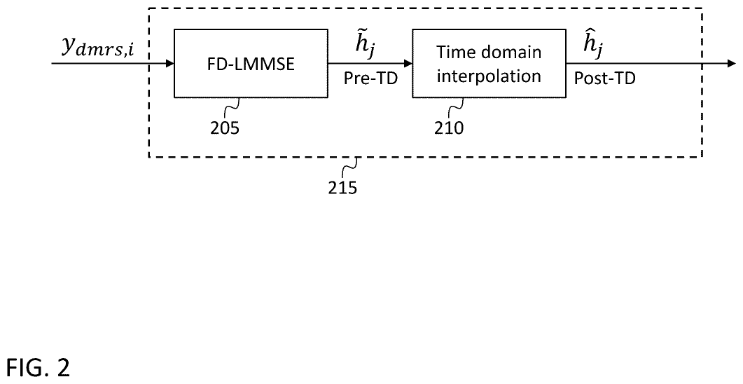

Furthermore, hik may be defined as the result of frequency domain linear minimum mean square estimation FD-LMMSE channel estimation and ĥⱼₖ may be defined as the result of as FD-LMMSE with time domain interpolation (FD-LMMSE+TDI) channel estimation. FIG. 2 is a block diagram showing FD-LMMSE channel estimation performed in an FD-LMMSE block 205, and time domain interpolation performed in a time domain interpolation block 210; the cascade of these two blocks forms a frequency domain linear minimum mean square estimation with time domain interpolation block 215. Considering the presence of channel estimation error, the channel estimation error eⱼₖ may be defined as

$${e}_{jk} = {h}_{jk} - {\hat{h}}_{jk}$$

with

$$E \{ {\vert {e}_{jk} \vert}^{2} \} = {σ}_{{e}_{jk}}^{2} .$$

For FD-LMMSE channel estimation (CE),

$${\tilde{h}}_{jk} = {w}_{jk}^{H} y$$

with wⱼₖ representing FD-LMMSE filter weights applied for channel estimation of the k-th DMRS RE and the j-th layer, which may be obtained as

$${w}_{jk}^{H} = {r}_{jk}^{H} {R}_{f}^{- 1} , \\ {r}_{jk}^{H} = E \{ {y}^{H} {h}_{jk} \} , and \\ {R}_{f} = E \{ {yy}^{H} \} .$$

For the one DMRS port case
R_{f}=R_{p,p}+σₙ²I, where R_{p,p} is the autocorrelation R_{p,p}=E{h₀h₀^{H}}, and for the two DMRS port case

$${R}_{f} = {X}_{0} {R}_{p , p} {X}_{0} + {X}_{1} {R}_{p , p} {X}_{1}^{H} + {σ}_{n}^{2} I , and \\ E \{ {y}^{H} {h}_{jk} \} E \{ {yy}^{H} \} .$$

The system model and the defined notations used herein are summarized in Table 1.

TABLE 1
Summary of the system model definitions and the notations

| | One DMRS Port | Two DRMS ports |
|---|---|---|
| Received signal over k-th | yₖ = hₖ + nₖ | yₖ = h_{k,0}x₀ + h_{k,1}x₁ + nₖ |
| DMRS RE | | |
| Channel power | E{\|hₖ \|²} = 1 | E{\|h_{k,j} \|²} = 1 |
| Vector of received signals | y = h + n | y = X₀h₀ + X₁h₁ + n |
| y = [y₀, . . . , y_{N}_{ₚ}₋₁]^{T} | | X₀ = I_{N}_{ₚ} |
| | | X₁ = diag(1, −1, . . . , |
| | | 1, −1) |
| Frequency correlation | R_{f} = R_{p,p} + σₙ²I | R_{f} = X₀R_{p,p}X₀ + |
| | | X₁R_{p,p}X₁^{H} + σₙ²I |
| LMMSE filter weights | wₖ^{H} = rₖ^{H}R_{f}⁻¹ | w_{k,j}^{H} = r_{k,j}^{H}R_{f}⁻¹ |
| | rₖ^{H} = E{y^{H}hₖ} | r_{k,j}^{H} = E{y^{H}h_{k,j}} |
| FD-LMMSE Channel | \tilde{h}ⱼₖ = wⱼₖ^{H}y with wⱼₖ = [w_{j,k,0}, . . . ,w_{j,k,N}_{ₚ}₋₁]^{H} | |
| estimation | | |
| Time domain interpolation | \tilde{h}ⱼ(0) = v₀\tilde{h}ⱼ(0) + v₁\tilde{h}ⱼ(1) | |
| (TDI) | | |

| | |
|---|---|
| Channel estimation error | eⱼₖ = hⱼₖ − ĥⱼₖ |
| w̅ⱼ | $\frac{1}{{N}_{p}} {\sum }_{k} \vert {w}_{j , k , k} \vert$ |
| ρ | $ρ = \frac{4}{{N}_{p}} {\sum }_{k} {{\sum }^{⌊ \frac{{N}_{p}}{4} ⌋}}_{l = - ⌊ \frac{{N}_{p}}{4} ⌋} {\vert {w}_{j , k , \frac{{N}_{p}}{2} + 2 l} \vert}^{2}$ |
| P_{w} | ${P}_{{w}_{j}} = \frac{1}{{N}_{p}} {\sum }_{k} {\sum }_{l = 0}^{{N}_{p} - 1} {\vert {w}_{j , k , l} \vert}^{2}$ |

Noise power estimation bias correction in the presence of CE error may be performed, for example, by (i) estimating and correcting for the noise power estimation bias for ideal FD-LMMSE (with ideal signal to noise ratio (SNR), and an ideal power distribution profile (PDP)), or by (ii) estimating and correcting for the noise power estimation bias for non-ideal FD-LMMSE (with estimated SNR, and an ideal PDP).

Estimating and correcting for the noise power estimation bias for ideal FD-LMMSE (with ideal signal to noise ratio (SNR), and an ideal power distribution profile (PDP)) may involve using the assumption that the FD-LMMSE CE is obtained using ideal PDP and ideal SNR. The noise power estimation bias may be analyzed (i) after FD-LMMSE CE, or (ii) after FD-LMMSE+TDI CE.

For the sake of simplicity, to analyze noise power estimation bias after FD-LMMSE CE, the sub-carrier index k may be dropped; then, for noise power estimation, the estimated noise power \tilde{σ}ₙ² may be calculated as:

$${\tilde{σ}}_{n}^{2} + E \{ {\vert y - {y}_{rec} \vert}^{2} \} = E \{ {\vert y - {\sum }_{j} {\tilde{h}}_{j} {x}_{j} \vert}^{2} \}$$

Where the recreated signal using the channel estimation y_{rec} is obtained as y_{rec}=Σⱼhⱼxⱼ. By defining \tilde{h}ⱼ=hⱼ+eⱼ and substituting y=Σⱼhⱼxⱼ, it may be shown that

$$y - {\sum }_{j} {\tilde{h}}_{j} {x}_{j} = {\sum }_{j} {h}_{j} {x}_{j} + n - {\sum }_{j} ( {h}_{j} + {e}_{j} ) {x}_{j} = n - {\sum }_{j} {e}_{j} {x}_{j} .$$

Therefore,

$$\begin{matrix}{\tilde{σ}}_{n}^{2} = E \{ {\vert y - {\sum }_{j} {\tilde{h}}_{j} {x}_{j} \vert}^{2} \} \\ = E ( y - {\sum }_{j} {\tilde{h}}_{j} {x}_{j} ) {( y - {\sum }_{j} {\tilde{h}}_{j} {x}_{j} )}^{*} \} \\ = E \{ ( y - {\sum }_{j} {\tilde{h}}_{j} {x}_{j} ) {( n - {\sum }_{j} {e}_{j} {x}_{j} )}^{*} \}\end{matrix} \qquad ( 1 )$$

Following the orthogonality principle, it follows that E{yeⱼ*xⱼ*}=0 and E{\tilde{h}ₗeⱼxᵢxⱼ*}=0 for all l and j. Therefore

$$\begin{matrix}{\tilde{σ}}_{n}^{2} = E \{ ( y - {\sum }_{j} {\tilde{h}}_{j} {x}_{j} ) {n}^{*} \} \\ = E \{ ( n - {\sum }_{j} {e}_{j} {x}_{j} ) {n}^{*} \} \\ = {σ}_{n}^{2} - {\sum }_{j} E \{ {e}_{j} {x}_{j} {n}^{*} \}\end{matrix} \qquad ( 2 )$$

In general, for LMMSE estimation with LMMSE filter weight of wⱼ^{H}=rⱼ^{H}R_{f}⁻¹, assuming E{|hⱼ|²}=1,

$$\begin{matrix}E \{ {e}_{j} {x}_{j} {n}^{*} \} = E \{ ( {w}_{j}^{H} y - {h}_{j} ) {x}_{j} {n}^{*} \} \\ = E \{ {w}_{j}^{H} {yx}_{j} {n}^{*} \} \\ = E \{ {w}_{j}^{H} {x}_{j} {σ}_{n}^{2} {1}_{k} \} \\ = \vert {w}_{j , k , k} \vert {σ}_{n}^{2}\end{matrix} \qquad ( 3 )$$

where w_{j,k,k} is the k, k^{th} element of wⱼ, 1ₖ denotes a one-hot vector with a k-th element being one and the fact that E{yn*}=σₙ²1ₖ and the fact that sign(w_{j,k,k})=xⱼ has been used. Here w_{j,k,k} is the weight applied to the k-th received DMRS sample in the estimation of the channel at the k-th DMRS RE. Finally,

$${\tilde{σ}}_{n , k}^{2} = {σ}_{n}^{2} ( 1 - {\sum }_{j} \vert {w}_{jk , k} \vert ) .$$

Since noise power estimation is carried over the entire set of DMRS REs, combining the contribution from all DMRS RE locations, for both the one DMRS port and the two DMRS port cases,

$${\tilde{σ}}_{n}^{2} = \frac{1}{{N}_{p}} {\sum }_{k} {\tilde{σ}}_{n , k}^{2} = {σ}_{n}^{2} ( 1 - {\sum }_{j} {\overline{w}}_{j} ) \qquad ( 4 )$$

with

$${\overline{w}}_{j} = \frac{1}{{N}_{p}} {\sum }_{k} \vert {w}_{j , k , k} \vert \qquad ( 5 )$$

For the one DMRS port case, it can be shown that

E{eₖxₖnₖ*}=σₑ², where σₑ² is the variance of the channel estimation error,
and

$$\frac{1}{{N}_{p}} {\sum }_{k} {σ}_{e , k}^{2} = {\overline{w}}_{0} {σ}_{n}^{2} .$$

Considering the 5G DMRS structure, it is straightforward to extend the present results to the three and four DMRS port cases, where the third and fourth DMRS ports are assigned to a different code division multiplexing (CDM) group than the 1^{st} and 2^{nd} DMRS port. Therefore, the estimated noise power is the average of noise power estimation over both CDM groups, which may be expressed as

$${\tilde{σ}}_{n}^{2} = \frac{1}{2 {N}_{p}} {\sum }_{k} {\tilde{σ}}_{n , k}^{2} = {σ}_{n}^{2} ( 1 - \frac{{\sum }_{j} {\overline{w}}_{j}}{2} ) .$$

The analysis of noise power estimation bias after FD-LMMSE+TDI CE may proceed as follows. The two DMRS symbol case may be considered, and s∈{0,1} may be defined as the DMRS OFDM-symbol index.

By defining ĥ_{j,k}(s) as post TD-LMMSE channel estimation over k-th DMRS RE of s-th DMRS symbol, and by dropping the DMRS RE index and dropping the DMRS port index, it may be shown that

$$\hat{h} ( 0 ) = [ {v}_{0} , {v}_{1} ] [ \begin{matrix}\tilde{h} ( 0 ) \\ \tilde{h} ( 1 )\end{matrix} ] {w}^{H} ( {v}_{0} y ( 0 ) + {v}_{1} y ( 1 ) ) \qquad ( 6 )$$

where v₀ and v₁ are the weights used for time domain interpolation, and the general TDI case has been considered without any restricting assumption on the time domain (TD) interpolation structure. Applying general TDI would prevent the use of the orthogonality principle, as FD-LMMSE+TDI is not true two dimensional (2D) LMMSE. Therefore, a different approach may be used. The one DMRS port case is considered next and the two DMRS port case is considered further below.

A noise power estimate after TD interpolation for one DMRS port may be calculated as follows. Following Equation (6), for the one DMRS port case,

$$\begin{matrix}{\hat{σ}}_{n}^{2} = E \{ {\vert {y}_{k} ( 0 ) - {w}_{k}^{H} ( {v}_{0} y ( 0 ) + {v}_{1} y ( 1 ) ) {x}_{k} \vert}^{2} \} \\ = \begin{matrix}E \{ {\vert {y}_{k} ( 0 ) \vert}^{2} \} + {w}_{k}^{H} E \{ ( {v}_{0} y ( 0 ) + {v}_{1} y ( 1 ) ) {( {v}_{0} y ( 0 ) + {v}_{1} y ( 1 ) )}^{H} \} {w}_{k} - \\ 2 R e \{ {w}_{k}^{H} E \{ {v}_{0} y ( 0 ) {y}_{k}^{*} ( 0 ) + {v}_{1} y ( 1 ) {y}_{k}^{*} ( 0 ) \} {x}_{k} \}\end{matrix}\end{matrix} \qquad ( 7 )$$

Defining γ=rₜ(t₁−t₀) as the time correlation between DMRS symbol 0 and DMRS symbol 1, it may be shown that

$$E \{ y ( 0 ) {y}^{H} ( 1 ) \} = γ ( {R}_{f} - {σ}_{n}^{2} I )$$

and

$$E \{ y ( 1 ) {y}_{k}^{*} ( 0 ) \} = γ ( {R}_{f}^{( k )} - {σ}_{n}^{2} {1}_{k} ) .$$

Furthermore,

$$E \{ y ( s ) {y}^{H} ( s ) \} = {R}_{f}$$

and

$$E \{ y ( s ) {y}_{k}^{*} ( s ) \} = {R}_{f}^{( k )} .$$

Substituting the above four equations into Equation (7), it may be shown that

$${\hat{σ}}_{n}^{2} = {σ}_{n}^{2} + 1 + ( {v}_{0}^{2} + {v}_{1}^{2} + 2 {v}_{0} {v}_{1} γ ) {w}^{H} {R}_{f} w - 2 {v}_{0} {v}_{1} γ {σ}_{n}^{2} {w}^{H} w - 2 ( {v}_{0} + {v}_{1} γ ) R e \{ {x}_{0} {w}^{H} {R}_{f}^{( k )} \} + 2 {v}_{1} γ {σ}_{n}^{2} {w}_{k}$$

Defining P_{w}=w^{H}w=Σₖ₌₀^{N}^{ₜ}⁻¹|wₖ|² and substituting

$${w}^{H} {R}_{f} w = {w}^{H} {R}_{f} {R}_{f}^{- 1} r = {w}^{H} r = 1 - {σ}_{e}^{2} = 1 - {σ}_{n}^{2} {w}_{k}$$

and

w^{H}R_{f}^{(k)}=r^{H}R_{f}⁻¹R_{f}^{(k)}=r^{H}1ₖ=E{|h|²}=1, results in

$$\begin{matrix}{\hat{σ}}_{n}^{2} = \begin{matrix}{σ}_{n}^{2} + 1 + ( {v}_{0}^{2} + {v}_{1}^{2} + 2 {v}_{0} {v}_{1} γ ) ( 1 - {σ}_{n}^{2} {w}_{k} ) - \\ 2 {v}_{0} {v}_{1} γ {σ}_{n}^{2} {P}_{w} - 2 ( {v}_{0} + {v}_{1} γ ) + 2 {v}_{1} γ {σ}_{n}^{2} {w}_{k}\end{matrix} \\ = \begin{matrix}{σ}_{n}^{2} + ( {( 1 - {v}_{0} )}^{2} + {v}_{1}^{2} - 2 ( 1 - {v}_{0} ) {v}_{1} γ ) - \\ ( {v}_{0}^{2} + {v}_{1}^{2} - 2 ( 1 - {v}_{0} ) {v}_{1} γ ) {σ}_{n}^{2} {w}_{k} - 2 {v}_{0} {v}_{1} γ {σ}_{n}^{2} {P}_{w}\end{matrix}\end{matrix} \qquad ( 8 )$$

Noise power estimation after TD interpolation for two DMRS ports may be performed as follows. For the two DMRS port case,

$$\begin{matrix}{\hat{σ}}_{n}^{2} = E \{ {\vert {y}_{k} ( 0 ) - ( {w}_{0 , k}^{H} {x}_{0 , k} + {w}_{1 , k}^{H} {x}_{1 , k} ) ( {v}_{0} y ( 0 ) + {v}_{1} y ( 1 ) ) \vert}^{2} \} \\ = \begin{matrix}E \{ {\vert {y}_{k} ( 0 ) \vert}^{2} \} + ( {w}_{0 , k}^{H} {x}_{0 , k} + {w}_{1 , k}^{H} {x}_{1 , k} ) \\ E \{ ( {v}_{0} y ( 0 ) + {v}_{1} y ( 1 ) ) {( {v}_{0} y ( 0 ) + {v}_{1} y ( 1 ) )}^{H} \} ( {w}_{0 , k} {x}_{0 , k}^{*} + {w}_{1 , k} {x}_{1 , k}^{*} ) \\ - 2 R e \{ ( {w}_{0 , k}^{H} {x}_{0 , k} + {w}_{1 , k}^{H} {x}_{1 , k} ) E \{ {v}_{0} y ( 0 ) {y}_{k}^{*} ( 0 ) + {v}_{1} y ( 1 ) {y}_{k}^{*} ( 0 ) \} \}\end{matrix}\end{matrix} \qquad ( 9 )$$

Similarly to the one DMRS port case, substituting E{y(0)y^{H}(1)}=γ(R_{f}−σₙ²I), E{y(1)yₖ(0)}=γ(R_{f}^{(k)}−σₙ²1ₖ), E{y(s)y^{H}(s)}=R_{f} and E{y(s)yₖ*(s)}=R_{f}^{(k)}, it may be shown that

$${\hat{σ}}_{n}^{2} = {σ}_{n}^{2} + 2 {P}_{h} + ( {v}_{0}^{2} + {v}_{1}^{2} + 2 {v}_{0} {v}_{1} γ ) ( {w}_{0}^{H} {x}_{0} + {w}_{1}^{H} {x}_{1} ) {R}_{f} ( {w}_{0} {x}_{0}^{*} + {w}_{1} {x}_{1}^{*} ) - 2 {v}_{0} {v}_{1} γ {σ}_{n}^{2} ( {w}_{0}^{H} {x}_{0} + {w}_{1}^{H} {x}_{1} ) ( {w}_{0} {x}_{0}^{*} + {w}_{1} {x}_{1}^{*} ) - 2 ( {v}_{0} + {v}_{1} γ ) R e \{ ( {w}_{0}^{H} {x}_{0} + {w}_{1}^{H} {x}_{1} ) {R}_{f}^{( k )} \} + 2 {v}_{1} γ {σ}_{n}^{2} {w}_{0 , k} + 2 {v}_{1} γ {σ}_{n}^{2} \vert {w}_{1 , k} \vert , \qquad ( 10 )$$

where Pₕ=E{|hⱼ|²} for j∈{0,1}

Following the definition of FD-LMMSE, (w₀x₀*+w₁x₁*)=R_{f}⁻¹(R_{f}^{(k)}−σₙ²1ₖ), and therefore

$$\begin{matrix}\begin{matrix}( {w}_{0}^{H} {x}_{0} + {w}_{1}^{H} {x}_{1} ) \\ {R}_{f} ( {w}_{0} {x}_{0}^{*} + {w}_{1} {x}_{1}^{*} )\end{matrix} = ( {w}_{0}^{H} {x}_{0} + {w}_{1}^{H} {x}_{1} ) {R}_{f} {R}_{f}^{- 1} ( {R}_{f}^{( k )} - {σ}_{n}^{2} {1}_{k} ) \\ = ( {R}_{f}^{( k )} - {σ}_{n}^{2} {1}_{k} ) {R}_{f}^{- 1} {R}_{f}^{( k )} - ( {w}_{0}^{H} {x}_{0} + {w}_{1}^{H} {x}_{1} ) {σ}_{n}^{2} {1}_{k} \\ = ( {R}_{f}^{( k )} - {σ}_{n}^{2} {1}_{k} ) {1}_{k} - {σ}_{n}^{2} ( {w}_{0 , k} + \vert {w}_{1 , k} \vert ) \\ = 2 {P}_{h} - {σ}_{n}^{2} ( {w}_{0 , k} + \vert {w}_{1 , k} \vert )\end{matrix} \qquad ( 11 )$$

$$and$$

$$( {w}_{0}^{H} {x}_{0} + {w}_{1}^{H} {x}_{1} ) {R}_{f}^{( k )} = {( {R}_{f}^{( k )} - {σ}_{n}^{2} {1}_{k} )}^{H} {R}_{f}^{- 1} {R}_{f}^{( k )} = {( {R}_{f}^{( k )} - {σ}_{n}^{2} {1}_{k} )}^{H} {1}_{k} = 2 {P}_{h} .$$

Defining

$$ρ = {( {x}_{0}^{*} {w}_{0} + {x}_{1}^{*} {w}_{1} )}^{H} ( {x}_{0}^{*} {w}_{0} + {x}_{1}^{*} {w}_{1} ) = 4 {\sum }_{l = - ⌊ \frac{{N}_{p}}{4} ⌋}^{⌊ \frac{{N}_{p}}{4} ⌋} {\vert {w}_{k , \frac{{N}_{p}}{2} + 2 l} \vert}^{2} \qquad ( 12 )$$

and substituting Equation (11) into Equation (10), it follows that

$${\hat{σ}}_{n}^{2} = {σ}_{n}^{2} + 2 {P}_{h} ( 1 + {v}_{0}^{2} + {v}_{1}^{2} + 2 {v}_{0} {v}_{1} γ - 2 {v}_{0} - 2 {v}_{1} γ ) - ( {v}_{0}^{2} + {v}_{1}^{2} + 2 {v}_{0} {v}_{1} γ - 2 {v}_{1} γ ) {σ}_{n}^{2} ( {w}_{0 , k} + \vert {w}_{1 , k} \vert ) - 2 {v}_{0} {v}_{1} γ {σ}_{n}^{2} ρ . \qquad ( 13 )$$

One simple sanity check is that it may be expected that \hat{σ}ₙ²=\tilde{σ}ₙ² for [v₀, v₁]=[1,0]which is essentially the no interpolation case. Further, by substituting [v₀, v₁]=[1,0]into Equation (13), it may be shown that σₙ² (1−w̅₀−w̅₁) which is equivalent to Equation (4) for FD-LMMSE based noise power estimation.

The derivation above results in a closed form expression for noise power estimated using FD-MMCE+TDI CE for any general form of TDI. A simple approximation may be made as follows, assuming FD-LMMSE+TDI CE provides ideal 2D-LMMSE estimation.

Equation (2) holds for true 2D-LMMSE as well such that the estimated noise power after time-domain interpolation, \hat{σ}_{2D-MMSE}², is given by:

$${\hat{σ}}_{2 D - MMSE}^{2} = {σ}_{n}^{2} - {\sum }_{j} E \{ {e}_{j} {x}_{j} {n}^{*} \}$$

where eⱼ denotes 2D-LMMSE CE error. Therefore, assuming FD-LMMSE+TDI approximates true 2D-LMMSE estimation,

eⱼ(0)=vwⱼ^{H}y(0)+v̅wⱼ^{H}y(1)−hⱼ(0) where v and v̅ are the time domain interpolation coefficients,

$${e}_{j} ( 1 ) = \overline{v} {w}_{j}^{H} y ( 0 ) + {vw}_{j}^{H} y ( 1 ) - {h}_{j} ( 1 ) ,$$

and for E{eⱼ(0)x₁(0)n*(0)}, it may be shown that

$$E \{ {e}_{j} ( 0 ) {x}_{j} ( 0 ) {n}^{*} ( 0 ) \} = E \{ ( {v}_{0} {w}_{j}^{H} y ( 0 ) + {v}_{1} {w}_{j}^{H} y ( 1 ) ) {x}_{j} ( 0 ) {n}^{*} ( 0 ) \} = {v}_{0} \vert {w}_{j , k , k} \vert {σ}_{n}^{2}$$

Therefore, a simple approximation for \hat{σ}ₙ² may be written as

$${\hat{σ}}_{n}^{2} \approx {σ}_{n}^{2} ( 1 - v {\sum }_{j} {\overline{w}}_{j} ) \qquad ( 14 )$$

which may be employed as an approximation over Equation (13).

Noise power estimation bias for non-ideal FD-LMMSE (with an estimated SNR, and an ideal PDP) may be performed as follows. The derivations above assume that an ideal SNR and an ideal PDP are used for FD-LMMSE CE which may not be a valid assumption in practice. In some embodiments, the estimated SNR from a previous slot is utilized in FD-LMMSE CE of the current slot. In some circumstances, it may be reasonable to assume that the SNR does not vary significantly from one slot to another. However, this assumption need not hold at all times and a sudden change of interference may occur from one slot to another, which may result in effectively varying the underlying SINR. The SNR mismatch between the true SNR and FD-LMMSE SNR may be addressed as follows. First, the difference between the true SNR and FD-LMMSE SNR may be acknowledged by defining the true frequency correlation R_{f,true} as

$${R}_{f , true} = E \{ {yy}^{H} \} = {R}_{f} + Δ I$$

where R_{f} denotes the frequency correlation utilized by FD-LMMSE, Δ=σₙ²−σ_{n,CE}² and σ_{n,CE}² is the estimated noise power from the previous slot which is utilized by FD-LMMSE.

The presence of an SNR mismatch may preclude the use of the orthogonality principle because, in the presence of such a mismatch, the FD-LMMSE is not the true LMMSE. As such, the more general case of FD-LMMSE+TDI CE for two DMRS ports may be considered first, and then the final result may be generalized to the FD-LMMSE CE only case or the one DMRS port case, or both. For the two DMRS port case, it may be shown that

$$( 15 )$$

$$\begin{matrix}{\hat{σ}}_{n}^{2} = E \{ {\vert y ( 0 ) - ( {w}_{0}^{H} {x}_{0} + {w}_{1}^{H} {x}_{1} ) ( {v}_{0} y ( 0 ) + {v}_{1} y ( 1 ) ) \vert}^{2} \} \\ = E \{ {\vert y ( 0 ) \vert}^{2} \} + ( {w}_{0}^{H} {x}_{0} + {w}_{1}^{H} {x}_{1} ) E \{ ( {v}_{0} y ( 0 ) + {v}_{1} y ( 1 ) ) {( {v}_{0} y ( 0 ) + {v}_{1} y ( 1 ) )}^{H} \} \\ ( {w}_{0} {x}_{0}^{*} + {w}_{1} {x}_{1}^{*} ) - 2 Re \{ ( {w}_{0}^{H} {x}_{0} + {w}_{1}^{H} {x}_{1} ) E \{ {v}_{0} y ( 0 ) {y}^{*} ( 0 ) + {v}_{1} y ( 1 ) {y}^{*} ( 0 ) \} \}\end{matrix}$$

Substituting E{y(0)y^{H}(1)}=γ(R_{f}+ΔI−σₙ²I), E{y(1)y*(0)}=γ(R_{f}^{(k)}+Δ1ₖ−σₙ²1ₖ), E{y(s)y^{H}(s)}=R_{f}+ΔI and E{y(s)y*(s)}=R_{f}^{(k)}+Δ1ₖ, it may be shown that

$$( 16 )$$

$${\hat{σ}}_{n}^{2} = {σ}_{n}^{2} + 2 + ( {v}_{0}^{2} + {v}_{1}^{2} + 2 {v}_{0} {v}_{1} γ ) ( {w}_{0}^{H} {x}_{0} + {w}_{1}^{H} {x}_{1} ) ( {R}_{f} + Δ I ) ( {w}_{0} {x}_{0}^{*} + {w}_{1} {x}_{1}^{*} ) - 2 {v}_{0} {v}_{1} γ {σ}_{n}^{2} ( {w}_{0}^{H} {x}_{0} + {w}_{1}^{H} {x}_{1} ) ( {w}_{0} {x}_{0}^{*} + {w}_{1} {x}_{1}^{*} ) - 2 ( {v}_{0} + {v}_{1} γ ) Re \{ ( {w}_{0}^{H} {x}_{0} + {w}_{1}^{H} {x}_{1} ) ( {R}_{f}^{( k )} + {Δ1}_{k} ) \} + 2 {v}_{1} γ {σ}_{n}^{2} {w}_{0 , k} + 2 {v}_{1} γ {σ}_{n}^{2} \vert {w}_{1 , k} \vert .$$

Equation (11) shows that

$$( {w}_{0}^{H} {x}_{0} + {w}_{1}^{H} {x}_{1} ) {R}_{f} ( {w}_{0} {x}_{0}^{*} + {w}_{1} {x}_{1}^{*} ) = 2 {P}_{h} - {σ}_{n , CE}^{2} ( {w}_{0 , k} + \vert {w}_{1 , k} \vert )$$

and Equation (12) states:

$$ρ = {( {x}_{0}^{*} {w}_{0} + {x}_{1}^{*} {w}_{1} )}^{H} ( {x}_{0}^{*} {w}_{0} + {x}_{1}^{*} {w}_{1} ) = 4 {\sum }_{l = - ⌊ \frac{{N}_{p}}{4} ⌋}^{⌊ \frac{{N}_{p}}{4} ⌋} {\vert {w}_{k , \frac{{N}_{p}}{2} + 2 l} \vert}^{2} .$$

Therefore, Equation (16) may be re-written as

$$( 17 )$$

$${\hat{σ}}_{n , k}^{2} = {σ}_{n}^{2} ( 1 + ρ ( {v}_{0}^{2} + {v}_{1}^{2} ) - 2 {v}_{0} ( {w}_{0 , k} + \vert {w}_{1 , k} \vert ) ) + 2 {P}_{h} ( 1 + {v}_{0}^{2} + {v}_{1}^{2} + 2 {v}_{0} {v}_{1} γ - 2 {v}_{0} - 2 {v}_{1} γ ) - {σ}_{n , CE}^{2} ( ( {v}_{0}^{2} + {v}_{1}^{2} + 2 {v}_{0} {v}_{1} γ - 2 {v}_{0} - 2 {v}_{1} γ ) ( {w}_{0 , k} + \vert {w}_{1 , k} \vert ) + ρ ( {v}_{0}^{2} + {v}_{1}^{2} + 2 {v}_{0} {v}_{1} γ ) )$$

Taking into account averaging over all DMRS RE locations, it may be shown that

\hat{σ}ₙ²=1/Nₚ\hat{σ}_{m,}²=σₙ²(1+ρ(v₀²+v₁²)−2v₀(w̅₀+w̅₁))+2Pₕ((1−v₀)²+v₁²−2v₁(1−v₀)γ)−σ_{n,CE}²((v₀²+v₁²+2v₀v₁γ−2v₀−2v₁γ)(w̅₀+w̅₁)+p(v₀²+v₁²+2v₀v₁γ)), where σ_{n,CE}² is the noise power employed for channel estimation.

The accuracy of SINR estimation may be enhanced using (i) bias compensation after FD-LMMSE CE, or (ii) bias compensation after FD-LMMSE plus TDI CE. Since FD-LMMSE only is a special case of FD-LMMSE+TDI CE with [v₀, v₁]=[1,0], then for the FD-LMMSE only case

$${\tilde{σ}}_{n}^{2} = {σ}_{n}^{2} ( 1 + ρ - 2 {\overline{w}}_{0} - 2 {\overline{w}}_{1} ) + {σ}_{n , prev}^{2} ( {\overline{w}}_{0} + {\overline{w}}_{1} - ρ ) .$$

The above equation gives the estimated noise power \tilde{σ}ₙ² in terms of the true noise power σₙ² and the previously estimated noise power σ_{n,prev}². As such, a bias-corrected noise power estimate \tilde{σ}_{n,corr}². may be calculated by solving the above equation for the true noise power σₙ² and setting the bias-corrected noise power estimate σ_{n,corr}². equal to the true noise power σₙ².

Following this approach, the bias in noise power estimation after FD-LMMSE CE may be estimated and removed using the following expressions:

$$( 18 )$$

$${σ}_{n , corr .}^{2} = \{ \begin{matrix}\frac{{\tilde{σ}}_{n}^{2} - {σ}_{n , prev}^{2} ( {\overline{w}}_{0} - {P}_{w} )}{1 - 2 {\overline{w}}_{0} + {P}_{w}} & One DMRS port \\ \frac{{\tilde{σ}}_{n}^{2} - {σ}_{n , prev}^{2} ( {\overline{w}}_{0} + {\overline{w}}_{1} - ρ )}{( 1 + ρ - 2 {\overline{w}}_{0} - 2 {\overline{w}}_{1} )} & Two DMRS port \\ \frac{{\tilde{σ}}_{n}^{2} - \frac{{σ}_{n , prev}^{2} ( {\overline{w}}_{0} + {\overline{w}}_{1} + {\overline{w}}_{2} - {ρ}_{01} - {P}_{{w}_{2}} )}{2}}{( 1 + \frac{{ρ}_{01} + {P}_{{w}_{2}}}{2} - {\overline{w}}_{0} - {\overline{w}}_{1} - {\overline{w}}_{2} )} & Three DMRS port \\ \frac{{\tilde{σ}}_{n}^{2} - \frac{{σ}_{n , prev}^{2} ( {\overline{w}}_{0} + {\overline{w}}_{1} + {\overline{w}}_{2} + {\overline{w}}_{3} - {ρ}_{01} - {ρ}_{23} )}{2}}{( 1 + \frac{{ρ}_{01} + {P}_{23}}{2} - {\overline{w}}_{0} - {\overline{w}}_{1} - {\overline{w}}_{2} - {\overline{w}}_{3} )} & Four DMRS port\end{matrix}$$

where w̅ⱼ is defined, in Equation (5), as

$${\overline{w}}_{j} = \frac{1}{{N}_{p}} {\sum }_{k} \vert {w}_{j , k , k} \vert$$

which is the average of the FD-LMMSE center tap at different DMRS RE locations, and where

$${P}_{{w}_{j}} = \frac{1}{{N}_{p}} {\sum }_{k} {w}_{j , k}^{H} {w}_{j , k} .$$

Each of the expressions above includes a first noise power estimate, Un, to which a multiplicative correction may be applied (e.g., in the case of one DMRS port, a multiplicative correction equal to

$$\frac{1}{1 - 2 {\overline{w}}_{0} + {P}_{w}} )$$

and to which an additive correction may be applied (e.g., in the case of one DMRS port, an additive correction equal to σ_{n,prev}²(w̅₀−P_{w})(or equal to

$$\frac{{σ}_{n , prev}^{2} ( {\overline{w}}_{0} - {P}_{w} )}{1 - 2 {\overline{w}}_{0} + {P}_{w}}$$

if a multiplicative correction is applied first)). The first noise power estimate may be calculated based on a first channel estimate, which may in turn be calculated based on a second noise power estimate, σ_{n,prev}². This second noise power estimate may be part of the additive correction, as in the example above in which the additive correction is equal to σ_{n,prev}²(w̅₀−P_{w}). In some embodiments, a corrected noise power estimate may be calculated as described above, and the process may then be iterated, at each iteration using the (e.g., corrected) noise power estimate from the previous iteration to calculate an updated channel estimate which is then used to calculate the uncorrected noise power estimate for the next iteration. For example, a second channel estimate may be calculated (before the calculation of the first channel estimate), based on the reference signal (e.g., the DMRS) and based on a fourth noise power estimate, and the second noise power estimate, σ_{n,prev}², may be a corrected estimate, calculated by applying a multiplicative correction or an additive correction (which may be based on the third noise power estimate) to a third noise power estimate (which is calculated based on the second channel estimate). The additive and multiplicative corrections may be based on (i) one or more linear minimum mean square error filter weights (e.g., w̅₀) or on (ii) one or more time domain interpolation weights (e.g., v₀), or on (iii) a correlation time (e.g., γ) of a channel corresponding to the first channel estimate (e.g., in addition to being based on the one or more linear minimum mean square error filter weights).

Bias compensation after FD-LMMSE plus TDI CE may be performed as follows. Noting that

P_{y}=2Pₕ+σₙ² (where P_{y} is defined as P_{y}=E{|yₖ|²}), it may be shown, using

$${SNR}_{CE} = \frac{2 {P}_{h}}{{σ}_{n , CE}^{2}}$$

(where SNR_{CE} is the signal to noise ratio employed for channel estimation), that

$${σ}_{n , CE}^{2} = \frac{{P}_{y} - {σ}_{n}^{2}}{{SNR}_{CE}} .$$

From Equation 8, it may be shown that

$${\hat{σ}}_{n}^{2} = {σ}_{n}^{2} ( 1 + ρ ( {v}_{0}^{2} + {v}_{1}^{2} ) - 2 {v}_{0} ( {\overline{w}}_{0} + {\overline{w}}_{1} ) ) + ( {P}_{y} - {σ}_{n}^{2} ) ( 1 + {v}_{0}^{2} + {v}_{1}^{2} + 2 {v}_{0} {v}_{1} γ - 2 {v}_{0} - 2 {v}_{1} γ ) - \frac{{P}_{y} - {σ}_{n}^{2}}{{SNR}_{CE}} ( ( {v}_{0}^{2} + {v}_{1}^{2} - 2 {v}_{0} - 2 {v}_{1} ( 1 - {v}_{0} ) γ ) ( {\overline{w}}_{0} + {\overline{w}}_{1} ) + ρ ( {v}_{0}^{2} + {v}_{1}^{2} + 2 {v}_{0} {v}_{1} γ ) ) = {σ}_{n}^{2} ( ρ ( {v}_{0}^{2} + {v}_{1}^{2} ) - 2 {v}_{0} ( {\overline{w}}_{0} + {\overline{w}}_{1} ) - {v}_{0}^{2} + 2 {v}_{0} - {v}_{1}^{2} + 2 {v}_{1} ( 1 - {v}_{0} ) γ + \frac{( {v}_{0}^{2} + {v}_{1}^{2} - 2 {v}_{0} - 2 {v}_{1} ( 1 - {v}_{0} ) γ ) ( {\overline{w}}_{0} + {\overline{w}}_{1} ) + ρ ( {v}_{0}^{2} + {v}_{1}^{2} + 2 {v}_{0} {v}_{1} γ )}{{SNR}_{CE}} ) + {P}_{y} ( 1 + {v}_{0}^{2} + {v}_{1}^{2} + 2 {v}_{0} {v}_{1} γ - 2 {v}_{0} - 2 {v}_{1} γ ) - \frac{{P}_{y}}{{SNR}_{CE}} ( ( {v}_{0}^{2} + {v}_{1}^{2} - 2 {v}_{0} - 2 {v}_{1} ( 1 - {v}_{0} ) γ ) ( {\overline{w}}_{0} + {\overline{w}}_{1} ) + ρ ( {v}_{0}^{2} + {v}_{1}^{2} + 2 {v}_{0} {v}_{1} γ ) ) = {scl}_{1} \times {σ}_{n}^{2} + {scl}_{2} \times {P}_{y}$$

The above equation gives the estimated noise power \hat{σ}ₙ² in terms of the true noise power σₙ² and the previously estimated signal to noise ratio SNRₚᵣₑᵥ, which depends on the previously estimated noise power. As such, a bias-corrected noise power estimate \hat{σ}_{n,corr}² may be calculated by solving the above equation for the true noise power o- and setting the bias-corrected noise power estimate \hat{σ}_{n,corr}². equal to the true noise power on to yield the following result, as a bias-corrected noise power estimate:

$${\hat{σ}}_{n , corr \cdot }^{2} = \frac{{\hat{σ}}_{n}^{2} - {scl}_{2} \times {P}_{y}}{{scl}_{1}} \qquad ( 19 )$$

with

$${scl}_{1} = \{ \begin{matrix}( 1 - {( 1 - {v}_{0} )}^{2} - {v}_{1}^{2} + 2 {v}_{1} ( 1 - {v}_{0} ) γ ) {w}_{0} - {P}_{w} ( {v}_{0}^{2} + {v}_{1}^{2} + 2 {v}_{0} {v}_{1} γ ) & One port \\ ( 1 - {( 1 - {v}_{0} )}^{2} - {v}_{1}^{2} + 2 {v}_{1} ( 1 - {v}_{0} ) γ ) ( {w}_{0} + {w}_{1} ) - {ρ}_{01} ( {v}_{0}^{2} + {v}_{1}^{2} + 2 {v}_{0} {v}_{1} γ ) & Two ports \\ \frac{( 1 - {( 1 - {v}_{0} )}^{2} - {v}_{1}^{2} + 2 {v}_{1} ( 1 - {v}_{0} ) γ ) ( {\overline{w}}_{0} + {\overline{w}}_{1} + {\overline{w}}_{2} ) - ( {ρ}_{01} + {P}_{{w}_{2}} ) ( {v}_{0}^{2} + {v}_{1}^{2} + 2 {v}_{0} {v}_{1} γ )}{2} & Three ports \\ \frac{( ( 1 - {( 1 - {v}_{0} )}^{2} - {v}_{1}^{2} + 2 {v}_{1} ( 1 - {v}_{0} ) γ ) ( {\overline{w}}_{0} + {\overline{w}}_{1} + {\overline{w}}_{2} + {\overline{w}}_{3} ) - ( {ρ}_{01} + {P}_{23} ) ( {v}_{0}^{2} + {v}_{1}^{2} + 2 {v}_{0} {v}_{1} γ ) )}{( 2 )} & Four ports\end{matrix}$$

$$and$$

$$offset = \{ \begin{matrix}{( 1 - {v}_{0} )}^{2} + {v}_{1}^{2} - 2 {v}_{1} ( 1 - {v}_{0} ) γ & One port \\ 2 ( {( 1 - {v}_{0} )}^{2} + {v}_{1}^{2} - 2 {v}_{1} ( 1 - {v}_{0} ) γ ) & Two ports \\ \frac{3}{2} ( {( 1 - {v}_{0} )}^{2} + {v}_{1}^{2} - 2 {v}_{1} ( 1 - {v}_{0} ) γ ) & Three ports \\ 2 ( {( 1 - {v}_{0} )}^{2} + {v}_{1}^{2} - 2 {v}_{1} ( 1 - {v}_{0} ) γ ) & Four ports\end{matrix}$$

$$and$$

$${scl}_{1} = \{ \begin{matrix}1 + {P}_{w} ( {v}_{0}^{2} + {v}_{1}^{2} ) - 2 {v}_{0} {\overline{w}}_{0} & One port \\ 1 + γ ( {v}_{0}^{2} + {v}_{1}^{2} ) - 2 {v}_{0} ( {\overline{w}}_{0} + {\overline{w}}_{1} ) & Two ports \\ 1 + \frac{( {ρ}_{01} + {P}_{{w}_{2}} )}{2} ( {v}_{0}^{2} + {v}_{1}^{2} ) - {v}_{0} ( ) & Three ports \\ & Four ports\end{matrix}$$

In some embodiments, the SINR estimation performed by the UE 105 may be enhanced using (i) bias compensation after FD-LMMSE CE, or (ii) bias compensation after FD-LMMSE plus TDI CE as described above. For example, as illustrated in FIG. 3, the UE 105 may receive, at 305, a reference signal (e.g., a DMRS signal, from the gNB 110); the UE 105 may generate, at 310, a first channel estimate, based on the reference signal; the UE 105 may calculate, at 315, a first noise power estimate (e.g., \tilde{σ}ₙ², in Equation 18, or \hat{σ}ₙ² in Equation 19); the UE 105 may calculate, at 320, a corrected noise power estimate (e.g., \tilde{σ}_{n,corr}². in Equation 18 or \hat{σ}_{n,corr}². in Equation 19); the UE 105 may receive, at 325, a transmission (e.g., a physical downlink shared channel (PDSCH) transmission, from the gNB 110); and the UE 105 may decode, at 330, the transmission, based on the corrected noise power estimate. In some embodiments, the calculating of the corrected noise power estimate includes calculating the corrected noise power estimate by applying a multiplicative correction to the first noise power estimate, the multiplicative correction being based on a linear minimum mean square error filter weight (e.g., w̅ₒ). The method may further include calculating, at 335, a second noise power estimate, wherein the calculating of the first channel estimate comprises calculating the first channel estimate further based on the second noise power estimate. The method may further include generating, at 340, a second channel estimate, based on the reference signal and on a fourth noise power estimate; and calculating, at 345, a third noise power estimate, wherein the calculating of the second noise power estimate comprises calculating the second noise power estimate by applying a correction to the third noise power estimate.

For example, in the case of bias compensation after FD-LMMSE CE, the multiplicative correction term may be or include a factor of

$$\frac{1}{1 - 2 {\overline{w}}_{0} + {P}_{w}}$$

(in the case of one DMRS port, according to Equation 18), and in the case of bias compensation after FD-LMMSE plus TDI CE, the multiplicative correction term may be or include a factor of

$$\frac{1}{{scl}_{1}}$$

(according to Equation 19). The first noise power estimate may be corrected (or also corrected) (as part of the process of forming the corrected noise power estimate), based on a second noise power estimate, which may be obtained before the first noise power estimate (and which may be given by σ_{n,prev}² in Equation 18 or which may be used to calculate SNRₚᵣₑᵥ, which is used in Equation 19).

In some embodiments, the calculating of the corrected noise power estimate comprises calculating the corrected noise power estimate by further applying an additive correction to the first noise power estimate. This additive correction may be based on the second noise power estimate. The additive correction may be given by Equation 18 for the case of bias compensation after FD-LMMSE, with the additive correction for one DMRS port being equal to σ_{n,prev}²(w̅₀−P_{w}) (or equal to

$$\frac{{σ}_{n , prev}^{2} ( {\overline{w}}_{0} - {P}_{w} )}{1 - 2 {\overline{w}}_{0} + {P}_{w}}$$

if a multiplicative correction is applied first). The additive correction may be given by Equation 19 for the case of bias compensation after FD-LMMSE plus TDI CE.

As mentioned above, in some embodiments, a corrected noise power estimate may be calculated as described above (e.g., using Equation 18 for the case of bias compensation after FD-LMMSE CE), and the process may then be iterated, at each iteration using the (e.g., corrected) noise power estimate from the previous iteration to calculate an updated channel estimate which is then used to calculate the uncorrected noise power estimate for the next iteration. For example, a second channel estimate may be calculated (before the calculation of the first channel estimate), based on the reference signal (e.g., the DMRS) and based on a fourth noise power estimate, and the second noise power estimate, σ_{n,prev}², may be a corrected estimate, calculated by applying a multiplicative correction or an additive correction (which may be based on the third noise power estimate) to a third noise power estimate (which is calculated based on the second channel estimate). The additive and multiplicative corrections may be based on (i) one or more linear minimum mean square error filter weights (e.g., w̅₀) or on (ii) one or more time domain interpolation weights (e.g., v₀), or on (iii) a correlation time (e.g., γ) of a channel corresponding to the first channel estimate (e.g., in addition to being based on the one or more linear minimum mean square error filter weights). As such, methods disclosed herein may improve the technology of wireless communications by enabling more accurate estimation of noise power, which may in turn enable more reliable decoding of received transmissions.

In some embodiments, direct un-biased noise power estimation is performed as follows:

$${\tilde{σ}}_{n}^{2} = E \{ y ( y - {y}_{rec} ) * \}$$

This estimate may be shown to be unbiased as

$$\begin{matrix}{\tilde{σ}}_{n}^{2} = E \{ y ( y - {y}_{rec} ) * \} \\ = E \{ {y ( y - {\sum }_{j} {\hat{h}}_{j} {x}_{j} )}^{*} \} \\ = E \{ {y ( n - {\sum }_{j} {e}_{j} {x}_{j} )}^{*} \}\end{matrix}$$

Applying the orthogonality principle, it may be shown that E{yeⱼ*xⱼ*}=0 and E{ĥₗeⱼxᵢxⱼ*}=0 for all l and j. Therefore,

$$\begin{matrix}{\tilde{σ}}_{n}^{2} = E \{ {yn}^{*} \} \\ = E \{ ( {\sum }_{j} {h}_{j} {x}_{j} + n ) {n}^{*} \} \\ = {σ}_{n}^{2}\end{matrix}$$

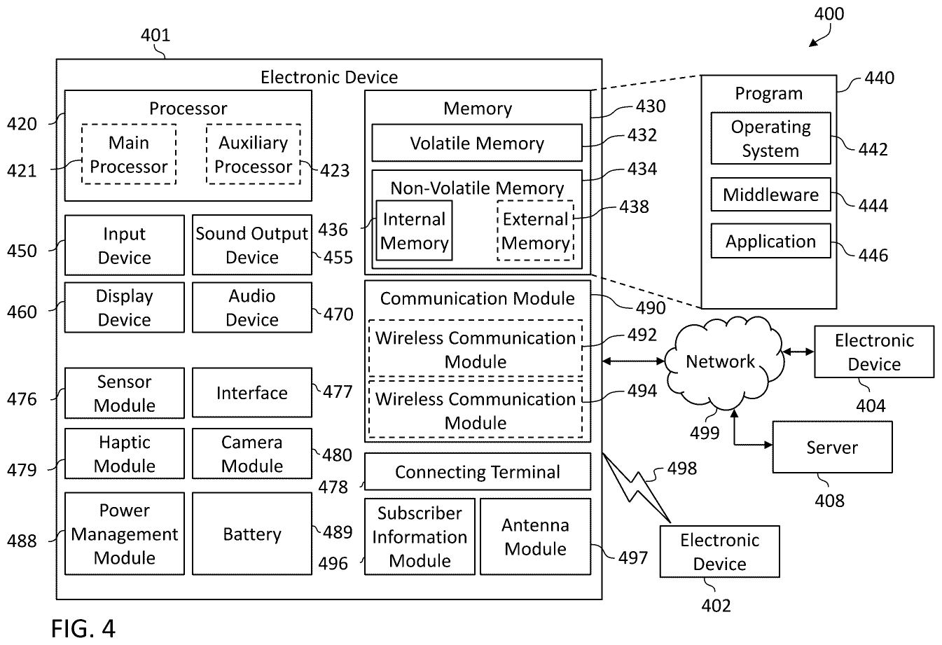

FIG. 4 is a block diagram of an electronic device (e.g., the UE 105) in a network environment 400, according to an embodiment.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
receiving a reference signal;
generating a first channel estimate, based on the reference signal;
calculating a first noise power estimate;
calculating a corrected noise power estimate by applying a multiplicative correction based on a linear minimum mean square error filter weight to the first noise power estimate;
receiving a transmission; and
decoding the transmission, based on the corrected noise power estimate.

2. The method of claim 1, further comprising calculating a second noise power estimate, wherein the calculating of the first channel estimate comprises calculating the first channel estimate further based on the second noise power estimate.

3. The method of claim 2, further comprising:
generating a second channel estimate, based on the reference signal and on a fourth noise power estimate; and
calculating a third noise power estimate,
wherein the calculating of the second noise power estimate comprises calculating the second noise power estimate by applying a correction to the third noise power estimate.

4. The method of claim 2, wherein the calculating of the corrected noise power estimate comprises calculating the corrected noise power estimate by further applying an additive correction to the first noise power estimate.

5. The method of claim 4, wherein the additive correction is based on the second noise power estimate.

6. The method of claim 5, wherein the additive correction is further based on one or more linear minimum mean square error filter weights.

7. The method of claim 1, wherein the multiplicative correction is further based on a time domain interpolation weight.

8. The method of claim 7, wherein the multiplicative correction is further based on a correlation time of a channel corresponding to the first channel estimate.

9. A system comprising:
one or more processors; and
a memory storing instructions which, when executed by the one or more processors, cause performance of:
receiving a reference signal;
generating a first channel estimate, based on the reference signal;
calculating a first noise power estimate;
calculating a corrected noise power estimate by applying a multiplicative correction based on a linear minimum mean square error filter weight to the first noise power estimate;
receiving a transmission; and
decoding the transmission, based on the corrected noise power estimate.

10. The system of claim 9, wherein:
the instructions, when executed by the one or more processors, further cause performance of calculating a second noise power estimate; and
the calculating of the first channel estimate comprises calculating the first channel estimate further based on the second noise power estimate.

11. The system of claim 10, wherein the instructions, when executed by the one or more processors, further cause performance of:
generating a second channel estimate, based on the reference signal and on a fourth noise power estimate; and
calculating a third noise power estimate,
wherein the calculating of the second noise power estimate comprises calculating the second noise power estimate by applying a correction to the third noise power estimate.

12. The system of claim 10, wherein the calculating of the corrected noise power estimate comprises calculating the corrected noise power estimate by further applying an additive correction to the first noise power estimate.

13. The system of claim 12, wherein the additive correction is based on the second noise power estimate.

14. The system of claim 13, wherein the additive correction is further based on one or more linear minimum mean square error filter weights.

15. The system of claim 9, wherein the multiplicative correction is further based on a time domain interpolation weight.

16. The system of claim 15, wherein the multiplicative correction is further based on a correlation time of a channel corresponding to the first channel estimate.

17. A system comprising:
means for processing; and
a memory storing instructions which, when executed by the means for processing, cause performance of:
receiving a reference signal;
generating a first channel estimate, based on the reference signal;
calculating a first noise power estimate;
calculating a corrected noise power estimate by applying a multiplicative correction based on a linear minimum mean square error filter weight to the first noise power estimate;
receiving a transmission; and
decoding the transmission, based on the corrected noise power estimate.

18. The system of claim 17, wherein the instructions, when executed by the means for processing, further cause performance of calculating a second noise power estimate, wherein the calculating of the first channel estimate comprises calculating the first channel estimate further based on the second noise power estimate.

19. The system of claim 18, wherein the instructions, when executed by the means for processing, further cause performance of:
generating a second channel estimate, based on the reference signal and on a fourth noise power estimate; and
calculating a third noise power estimate,
wherein the calculating of the second noise power estimate comprises calculating the second noise power estimate by applying a correction to the third noise power estimate.

20. The system of claim 18, wherein the calculating of the corrected noise power estimate comprises calculating the corrected noise power estimate by further applying an additive correction to the first noise power estimate.
